(19) United States
(12) Patent Application Publication
(10) Pub. No.: US 2008/0313048 A1
(43) Pub. Date: Dec. 18, 2008

(54) Dual input/output device point of sale terminal

(76) Inventor: David John Killian, Youngsville, NC (US)

Correspondence Address: HOLLAND & KNIGHT LLP, 2099 PENNSYLVANIA AVE, SUITE 100, WASHINGTON, DC, 20006, US

(21) Appl. No.: 12/149,613

(22) Filed: May 5, 2008

Related U.S. Application Data
(60) Provisional application No. 60/928,041, filed on May 7, 2007.

(51) Int. Cl. G06Q 20/00; G06Q 30/00

(52) U.S. Cl. 705/17; 705/16

(57) ABSTRACT

A dual input/output point of sale system allows a customer and a point of sale operator to use respective input/output devices, such as a touch screen, independently and cooperatively during a transaction.

### CROSS REFERENCE TO RELATED APPLICATION

This application is related to and claims priority of provisional patent application having Application No. 60/928,041 entitled “Dual Touch Screen Point of Sale Terminal.

### BACKGROUND OF THE INVENTION

Point of sale terminals are used in a wide variety of retail environments. However, normally such point of sale terminals allow for interaction with either a customer or an operator, but not both independently. For example, many supermarkets use loyalty promotions, where discounts can optionally be applied to the transaction based upon the identity of the customer using the system. In a typical such scenario, discounts are commonly based on a points redemption, e.g., the discount uses a specific number of points from the customer's personal store of points. It is desirable to allow the customer to view and select the items to be redeemed for points while the transaction is in progress, independent of the activities of the POS operator and before the end of the transaction.

### SUMMARY OF THE INVENTION

Embodiments of the present invention allow a customer and a point of sale (POS) operator to use respective input/output devices, such as touch screens, independently, asynchronously and cooperatively during a transaction. This allows a customer to view and select the items to be redeemed for points while the transaction is in progress, independent of the activities of the POS operator.

### BRIEF DESCRIPTION OF THE FIGURES

FIGS. 1 through 24 represent sample screens illustrating a work flow in accordance with an embodiment of the present invention.

FIG. 25 schematically illustrates an alternate view of the logical progression of the work flow in accordance with the example shown in FIGS. 1 through 24.

### DESCRIPTION OF THE PREFERRED EMBODIMENTS

Embodiments of the present invention allow a customer to interact with a point of sale (POS) transaction independently and asynchronously with the POS operator conducting the customer's transaction. One exemplary embodiment includes a TeamPOS 3000 equipped with two input/output devices, such as IR touch screens. The input/output devices need not be touch screens and can be any suitable input/output device for a POS. In the example embodiment, the two touch screens can serve as independent input/output devices, one for the customer and one for the POS operator. For example, an operator can initiate a POS transaction. Then in one embodiment, the two touch screens operate as two independent input/output devices for separate applications that can collaborate during the transaction. In this example, the two input/output devices interact with two applications that can collaborate. In another embodiment, the two input/output devices can be interacting with the same application serving each (, e.g., two or more) input/output devices independently. The collaboration between the input/output devices simulates some of the behavior of a multi-user operating system, such as appearing to have independent user input from respective user input devices.

Examples of the logical collaboration between two applications (or one application and two input/output devices) when deployed on a single system can occur in various way; two examples of which are described below. In an embodiment where there are two or more applications separately interacting with input/output devices, the architecture of the applications is preferably based on messaging principals such as those applicable to web services in general. In such an architecture, each visual component (e.g., displayed on the input/output devices) communicates independently with an application logic flow or state engine web service by exchanging specific messages with that engine. This engine in turn composes the message patterns of each application into a unified whole to make the collaboration between the applications appear seamless.

In embodiments of the present invention, such as discussed above, the input/output device (e.g., customer interface device (CID)) application is touch screen (mouse) driven. The Windows® specific collaboration element manages the input/output device (e.g., mouse) input focus shifts in such a fashion that priority is given to the POS operator input queue, making it appear that focus remains with the POS application while accepting input smoothly with customer input/output device.

An embodiment of the present invention, when deployed on a single machine, can employ an engine, or customer interface device collaboration element, that derives most of its functionality by carefully managing state within the Windows® operating system. The following references elements from Microsoft®'s Win32 API and .Net framework WindowsForms library. In the following explanation, it is assumed that:

There is a single CPU system running a Windows XP® or later operating system with the .Net 2.x or later framework installed; and both the customer's application and the operator's application are running on a single machine.

In this example, there are two input/output devices in the system, a primary (e.g., the operator's) and a secondary (e.g., the customer's). The secondary device is assumed to include a display that generates a mouse keyup/keydown interrupt to the operating system whenever it is activated, which in the case of a touch screen display, has it's surface is touched. In this example, there are two independent executables, each control one of the input/output devices. These applications exchange behavior information via messages described elsewhere. The application controlling the touch screen contains collaboration elements that provide the appearance of two independent user input devices. The collaboration elements consist of a high resolution timer, a Windows® message filter, a generic WinProc handler for each instantiated form, and an idle event handler, at the minimum, all of which are implemented using the services of the Windows® Application Programming Interface (Win32API), either natively or through the WinForms library. When it initializes, this application captures the current configuration of display geometries of both input/output devices and “entangles” its message pump with that of the application on the primary display via the AttachThreadInput Win32API. This entanglement allows the elementary units of work of the Windows® graphical user interface subsystem (a.k.a. Windows Messages) to be shared by the two applications, including the ability to move input focus between the applications. The message filter analyzes each windows message prior to dispatching it to the application. If the message is a LeftMouseButtonDown message, the high resolution time is reset; any resultant change of focus to the secondary display is captured by the WinProc handler and preserves the primary display's foreground window identity and input caret position. If the message is a LeftMouseButtonUp message the high resolution timer value is preserved. Aperiodically, when no windows messages are present, the operating system calls the idle event handler. The idle event handler in turn determines if a preconfigured interval since the last LeftMouseButtonDown event has elapsed and the focus is currently on the secondary display, it returns focus to the previously saved position on the primary display.

In an embodiment using a single system, the system can manage application “focus” such that input priority remains with the POS operator. For example, Windows® is, by design, a single user operating system with a single input queue for mouse and keyboard. In such an environment, an input/output device (e.g., a touch screen) operates like an additional mouse device, even though there is still only one logical mouse in the system. Even in Windows® multiple screen extended desktop, there is only one mouse cursor. Therefore, normally, if there are two applications running, one on each of the two screens, a click (a touch on one screen) moves ‘focus’ to that application and potentially away from the other. This is no problem for a single user, but with two users, each using respective input/output devices, this normally leads to focus contention, data loss, and/or extra keystrokes that are highly undesirable for a high throughput application and quite irritating to the users.

The system can be employed in a variety of environments, including retail sales or any environment where two input/output devices such as the touch screens would be desirable. Some examples include a supermarket, department stores, fast food, drug stores or any environment where a transaction is to occur. In a supermarket, the checkout lane is commonly supported by an externally system that provides support for loyalty promotions, e.g. discounts that can optionally be applied to the transaction in progress based upon the identity of the customer using the system. In this example, discounts can be actuated based on a ‘points redemption’ scheme, i.e. the discount ‘costs’ a specific number of ‘points’ from the customer's personal store of points. Neither the loyalty subsystem nor the described discounting behavior is unique. The software allows the customer to view and select the items to be redeemed for points while the transaction is in progress, independent of the activities of the POS operator and before the end of the transaction. Additionally this interaction requires modest hardware support. An example of such hardware includes x86 based processor or any other processor of the required capacity to timely process a transaction. The processor can run an operating system, such as the single user Windows® XP SP2 with adequate memory and a video adapter capable of driving two touch screens. Obviously, other single operating systems can be employed.

A supermarket is only one of a variety of possible scenarios where an interactive customer device in use while the POS transaction is in process could significantly change the workflow and throughput of conventional retail checkout while providing streamlined customer service.

The present invention can also be used in a remote deployment of the customer input/output device. And, while certain embodiments can use input/output devices on a single system, the customer input/output device could be deployed on a standalone computer connected to the POS system by a variety of communications links (e.g. Ethernet). There is no logical difference in the operation in this remote deployment scenario from that discussed above.

The operator and the customer interaction point are preferably, but need not be touch screens. Any suitable display and input devices could be used, including CRT terminals, LCD, plasma displays, voice output devices, printers, keyboards, mouse type device.

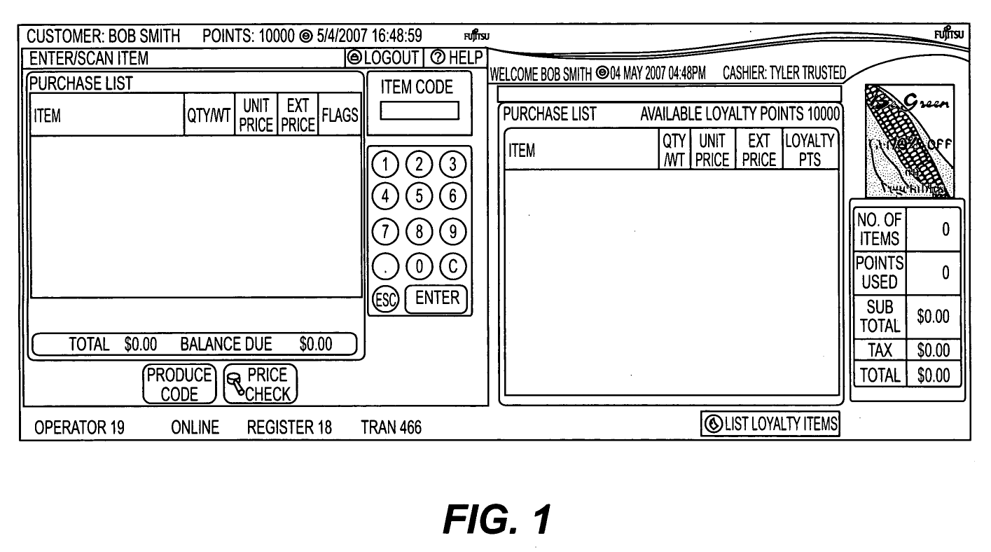

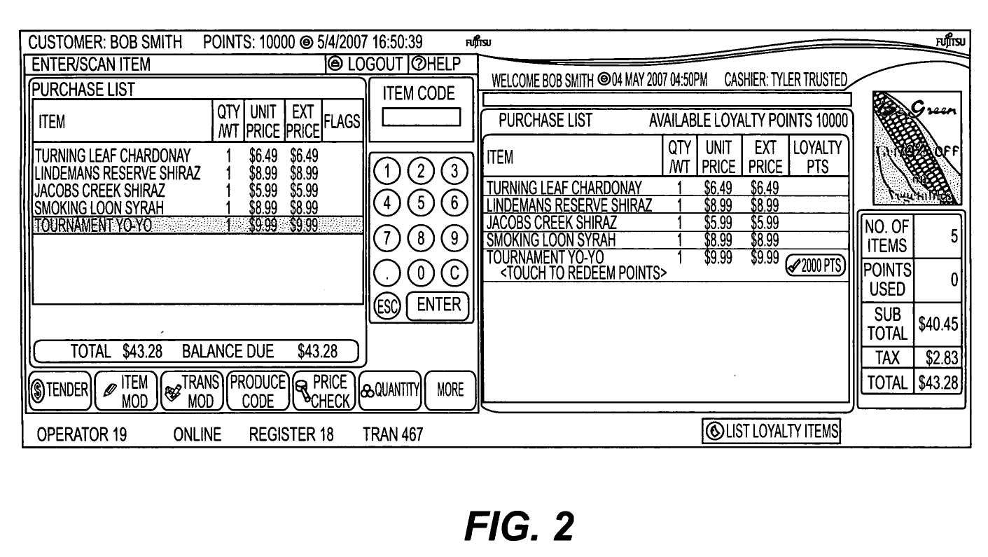

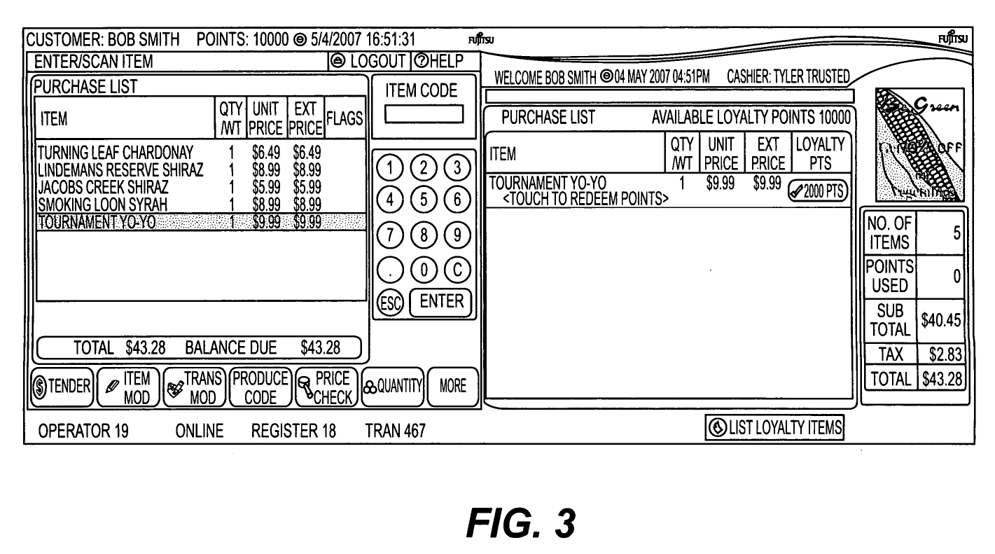

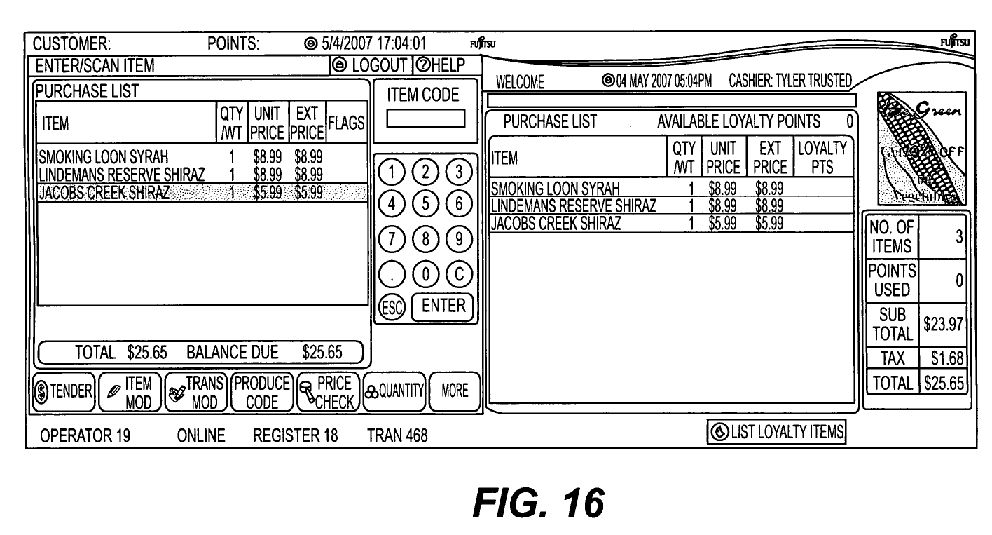

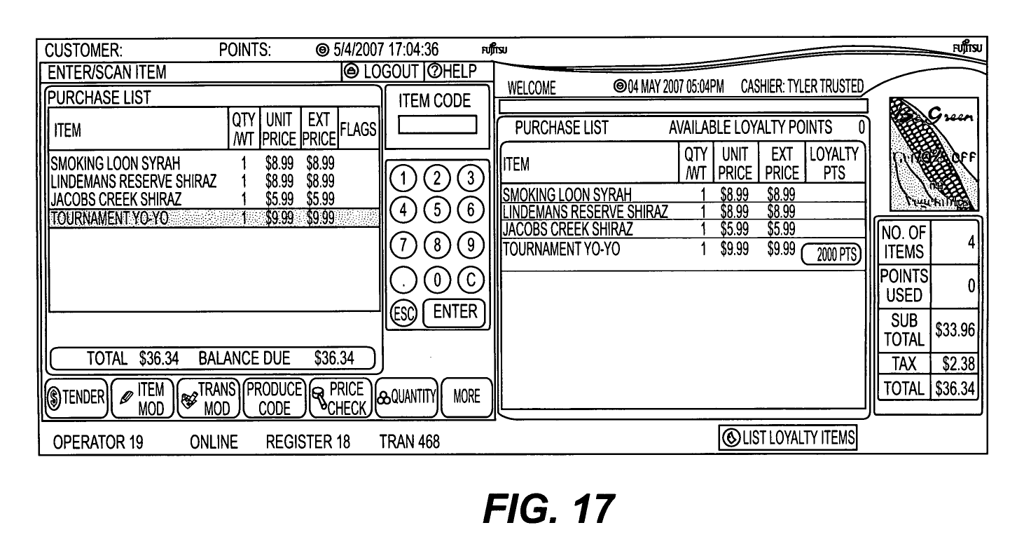

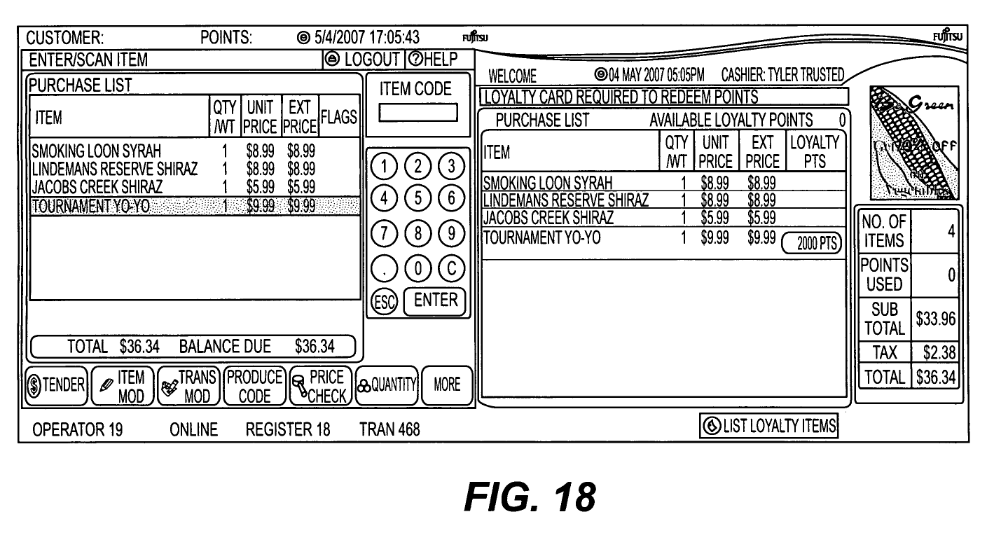

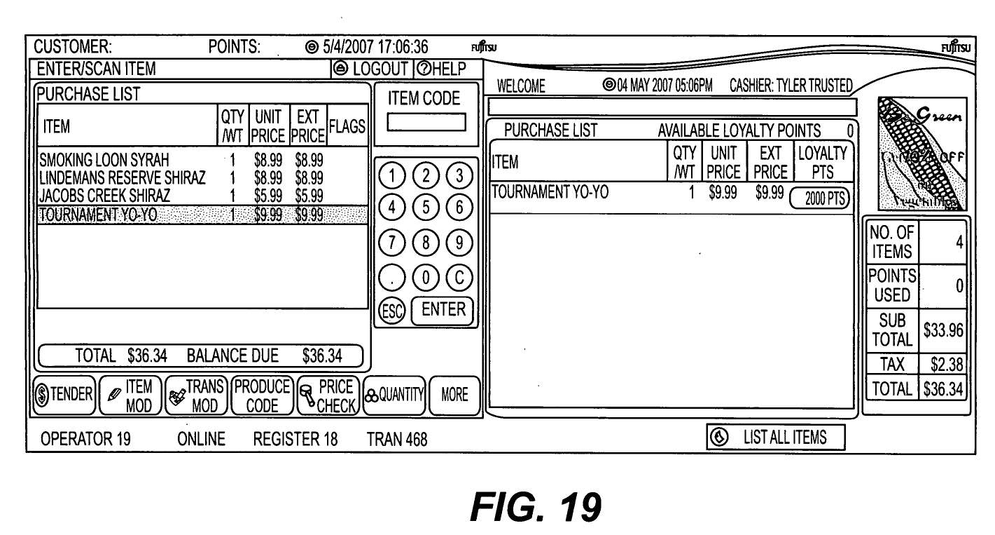

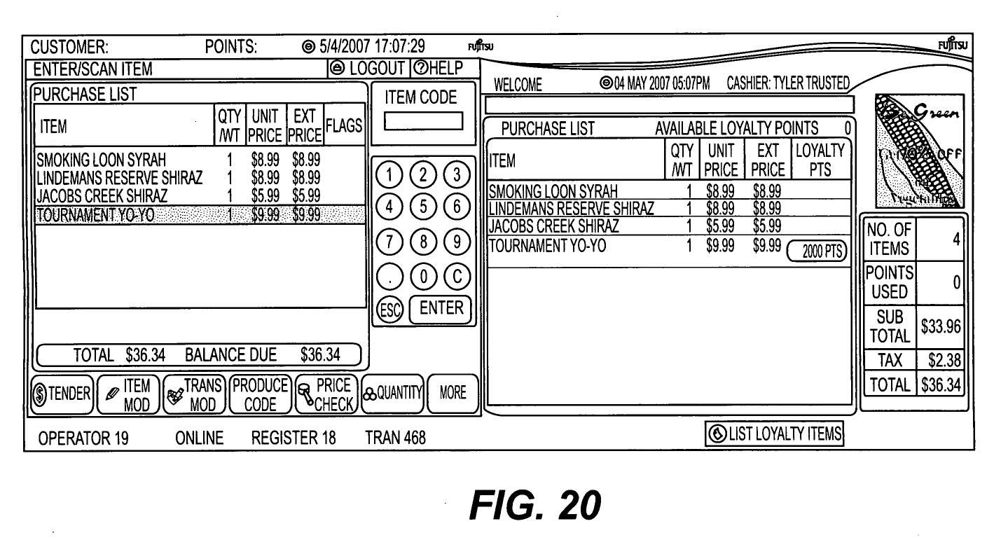

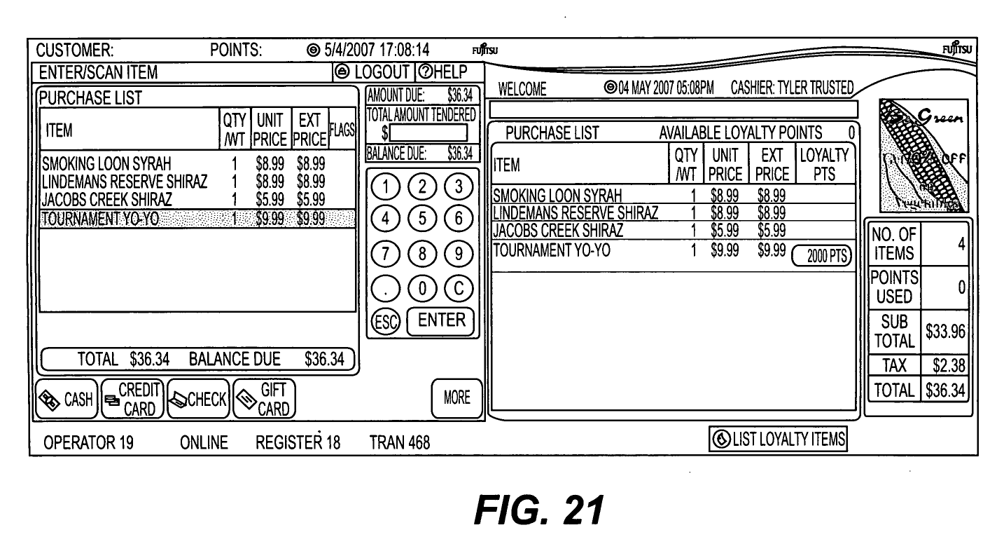

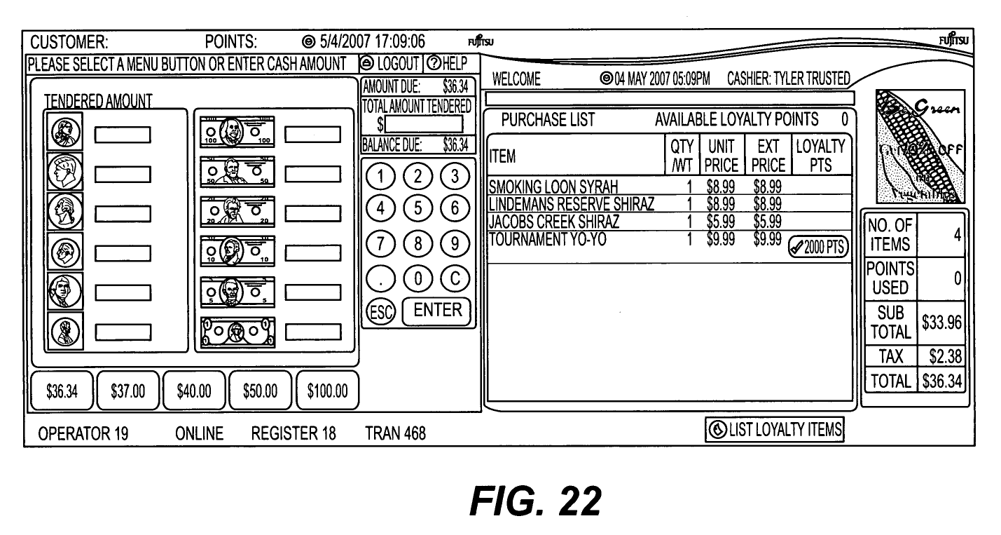

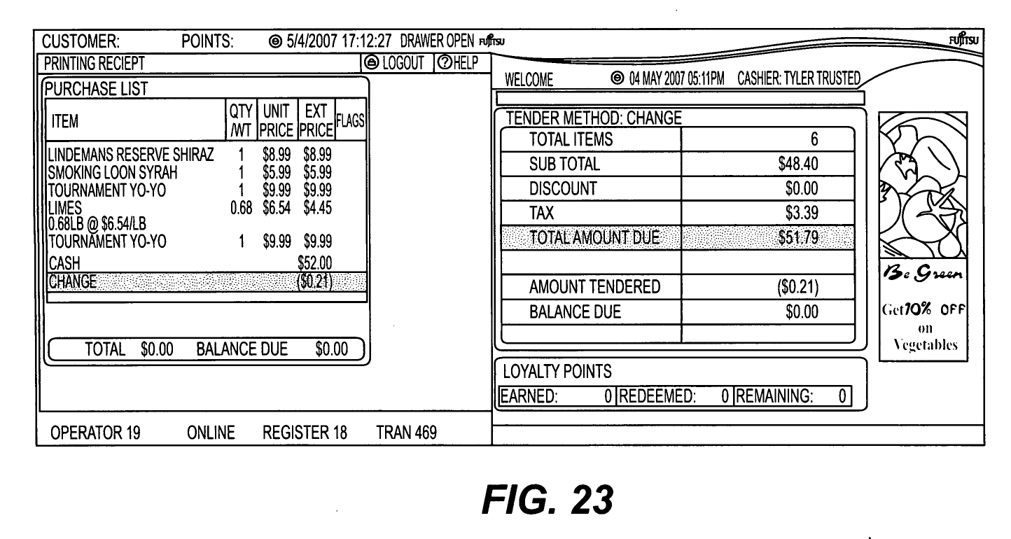

Referring to the figures, FIGS. 1-24 represent sample screens illustrating a work flow in accordance with an embodiment of the present invention. In FIGS. 1-24, the images show the POS operator display on the left and the customer display on the right and the same state in the workflow. FIG. 1 shows the screens when the POS operator is ready for a transaction. In one embodiment, the customer input/output device can have an integrated magnetic stripe reader. The customer swipes his loyalty card through the customer input/output device reader located integral with or separate from the customer input/output device. Then in FIG. 2, the operator scans additional items. The customer input/output device displays the items and indicates that one item is available for redemption; indicated in FIG. 2 by the rectangle with the text “2000 pts” preceded by a check mark. As the customer's order is processed, FIG. 3 shows the operator continuing to scan. But, as seen in FIG. 3, the customer can select a view that shows only the loyalty items.

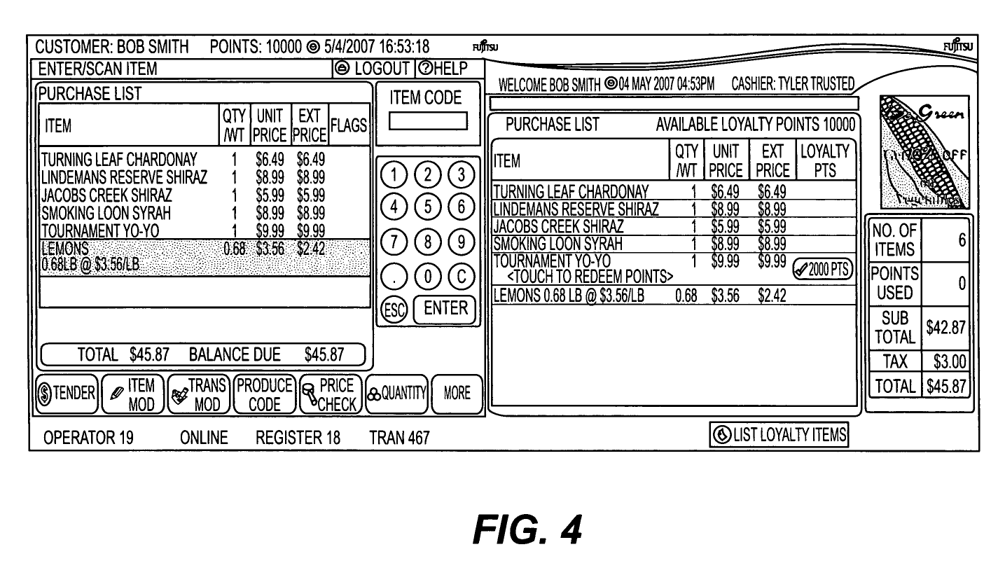

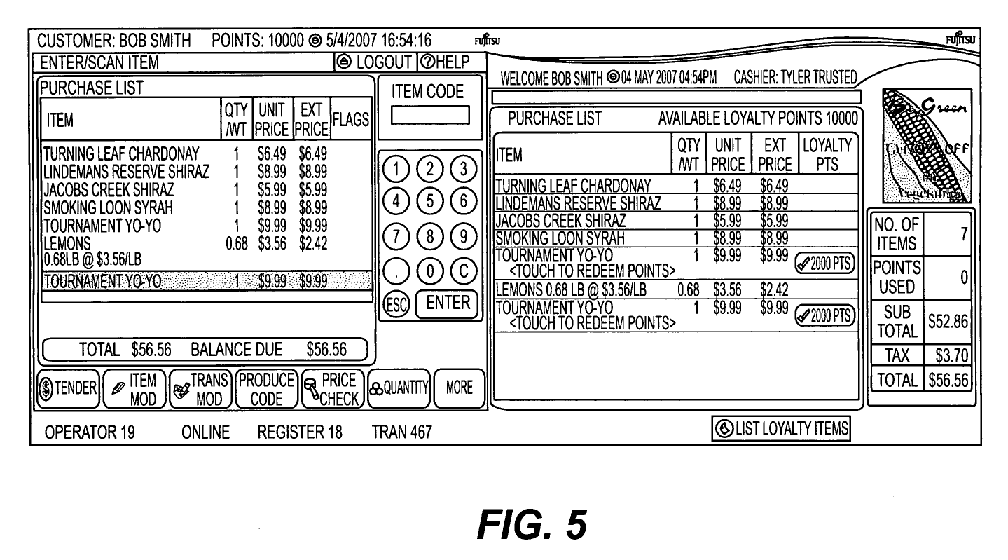

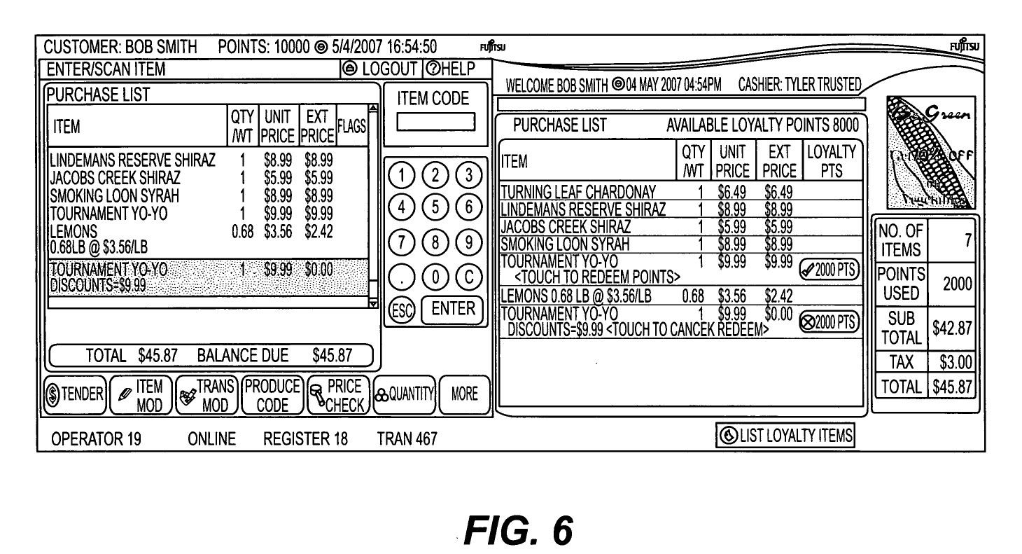

As seen in FIG. 4, the operator continues to scan items. But, in the FIG. 4 view, the customer selects a view that shows “all items.” FIG. 5 shows the displays when the operator scans a second loyalty item. The second loyalty item is indicated by the second rectangle including the text “2000 pts” preceded by a check mark. In FIG. 6, the highlighted row indicates that the customer elects to redeem one item, and the rectangle with the text “2000 pts” is preceded by an X. As FIG. 6 shows, the price of the redeemed item is updated to $0.00 in the operator's display

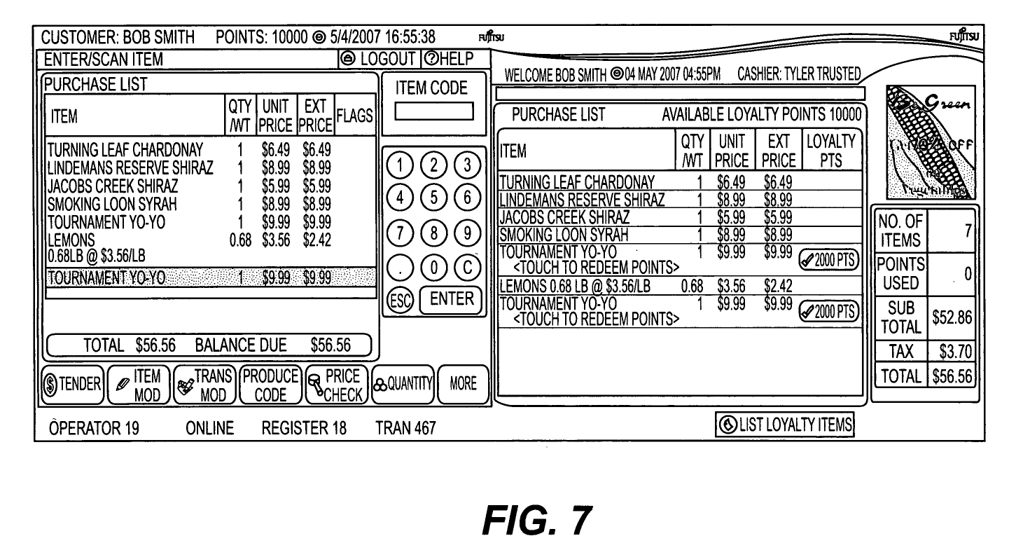

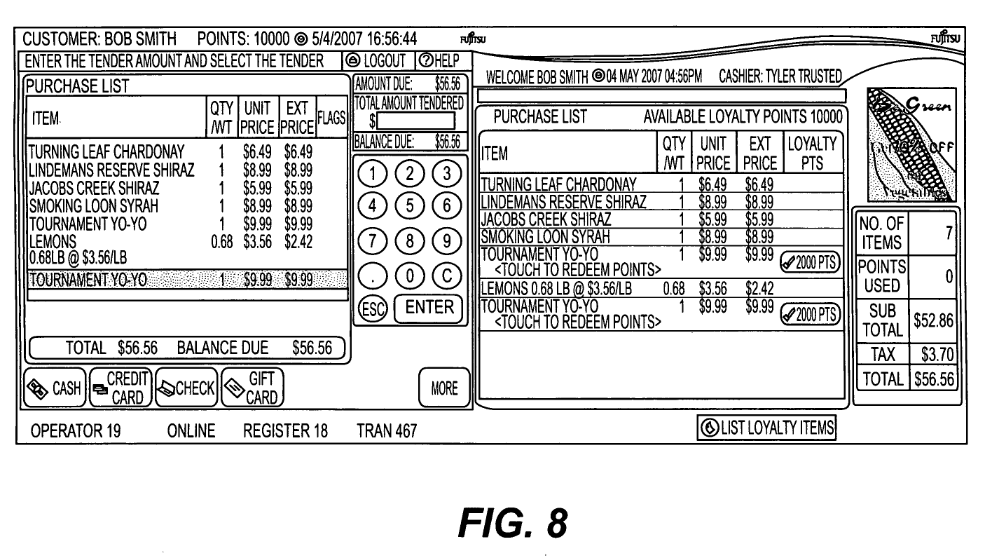

Referring to FIG. 7, this figure shows the situation where the customer elects to cancel the redemption. The operator display reflects the change showing the price $9.99. FIG. 8 shows an example of the screens when all customer items are scanned and the transaction enters the tendering phase. One indicator of this phase is change of buttons on the bottom of the operator display.

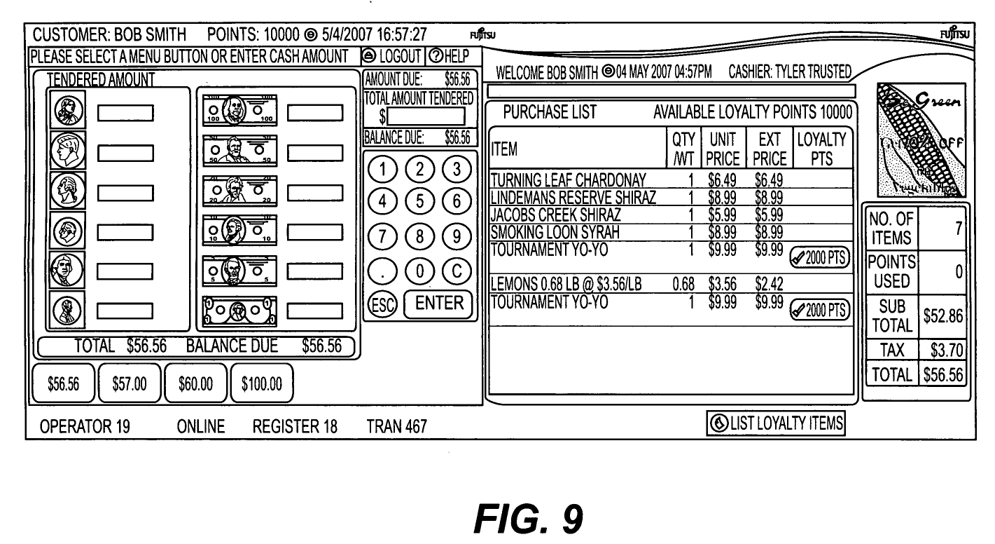

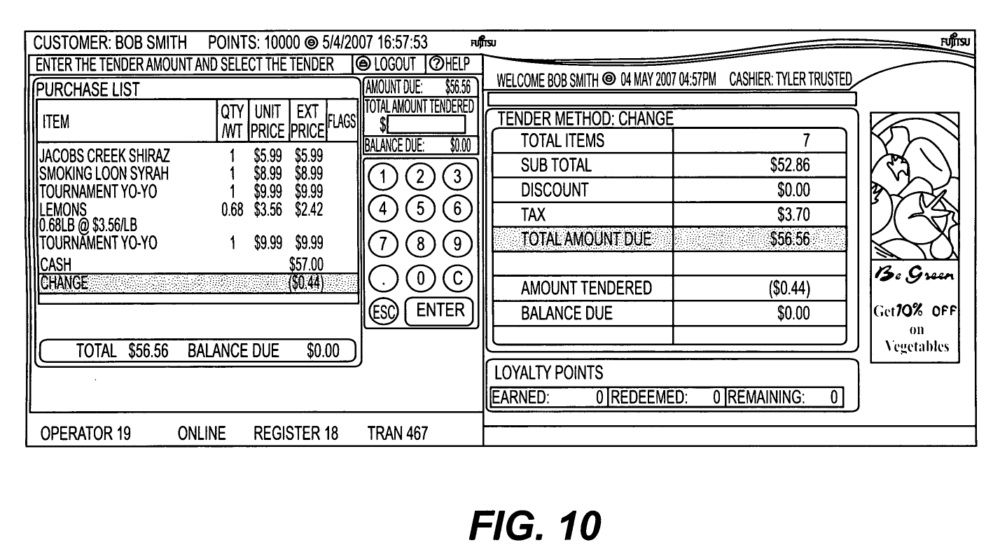

FIG. 9 shows the situation where the customer elects to pay with cash. In this situation, no further redemptions are allowed. In this example, this state is indicated by the rectangles with the text “2000 pts” being no longer preceded by a check mark and the rectangles having their color or some other feature changed to further indicate that the redemption option is no longer available to the customer. FIG. 10 shows the displays with the final transaction totals displayed for this example after the customer has tendered cash to the operator. Following completion of the transaction, such as the customer being given the needed change, the displays return to an initial state waiting for a customer/operator interaction.

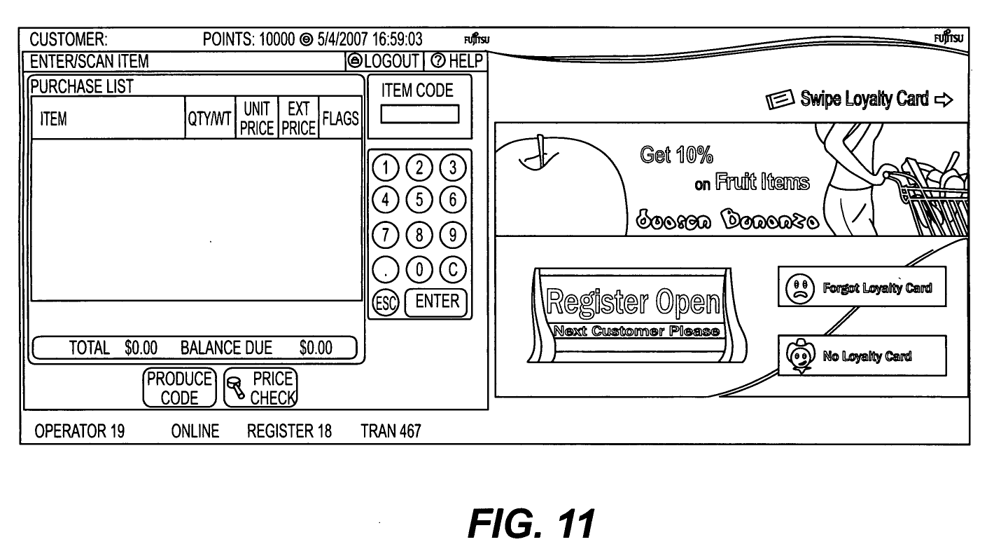

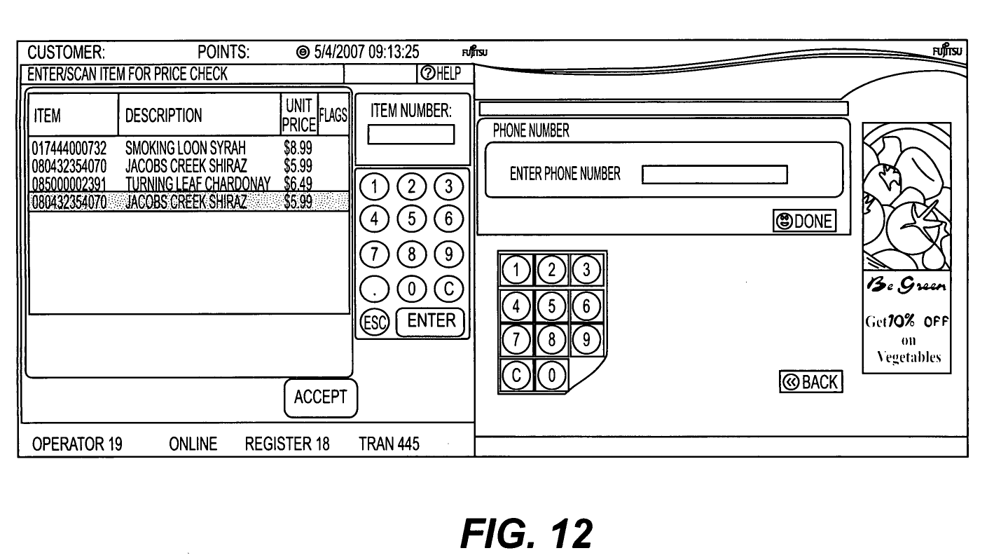

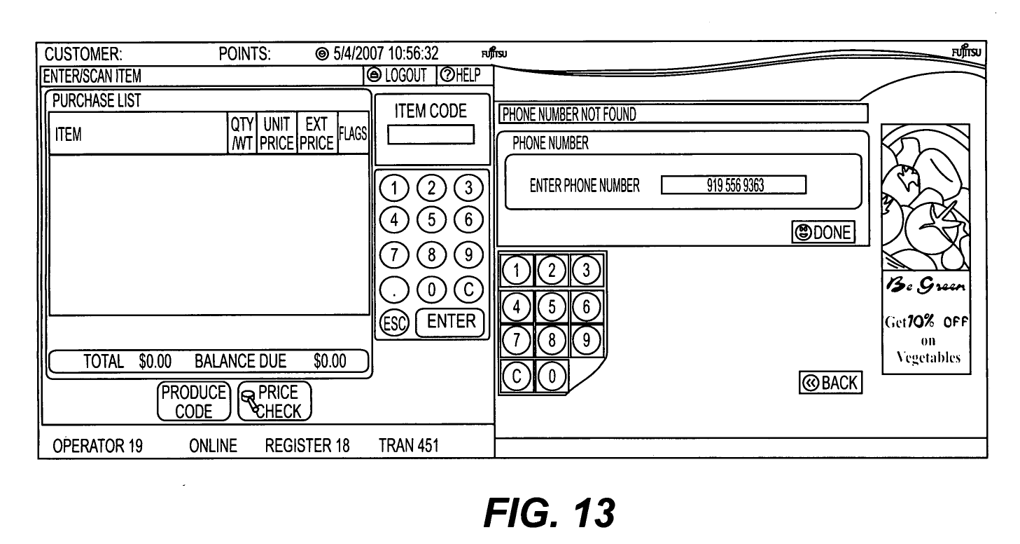

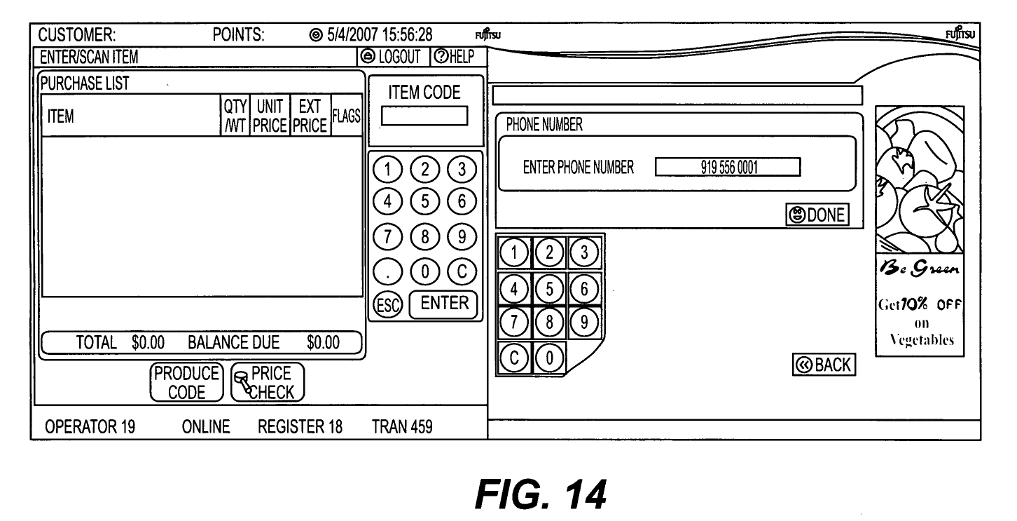

Referring now to FIG. 11, if the customer has forgotten his loyalty card and does not swipe his loyalty card, the customer can activate the “forgot loyalty card” flow. In the example shown in FIG. 11 this would be done by the customer activating the “Forgot Loyalty Card” button. In such a situation the customer information can be retrieved based on some customer data, such as the customer's phone number. One example of customer information is the customer's phone number. FIG. 12 shows an example of a screen allowing the customer to enter his phone number. If the customer phone number is found in the system, the work flow proceeds as described above from FIG. 2. FIG. 13 illustrates an example screen where the customer's phone number is not found, as indicated by the message in the customer's screen “Phone Number not Found.” The customer can reenter the phone number as shown in FIG. 14, or select “No Loyalty Card” work flow by activating that button as shown in FIG. 11 after, for example activating the “Back” button in FIG. 12, 13, or 14.

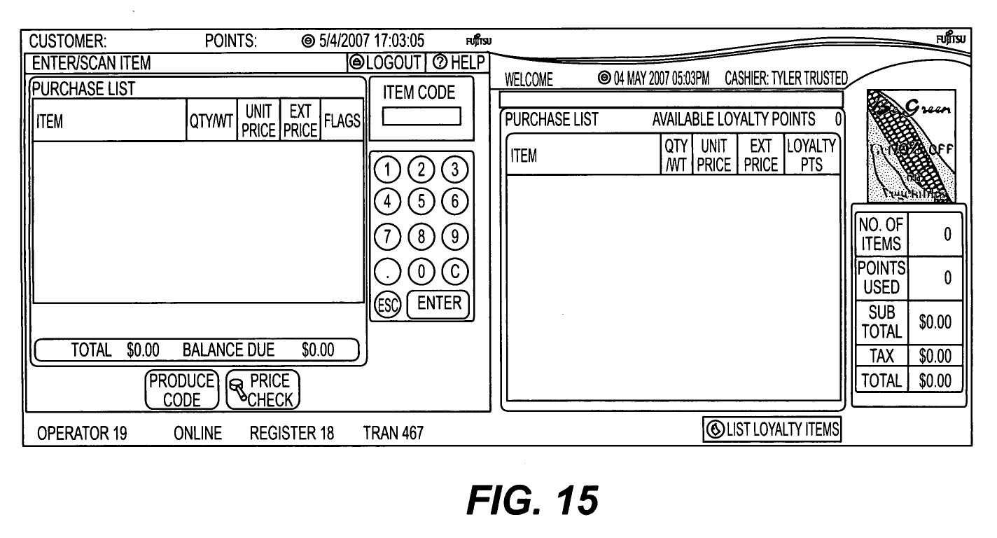

The “No Loyalty Card’ workflow is similar to that of the workflow discussed with respect to FIGS. 2-10 where the customer has his loyalty card. However, no customer information (e.g. name, available points, etc.) is displayed. Loyalty items are identified with a rectangle with the number of points, such as “2000 pts,” but it is not preceded by check mark. The rectangle can also have its color or some other feature changed to further indicate that redemption option is not available. This is shown in FIGS. 15-23.

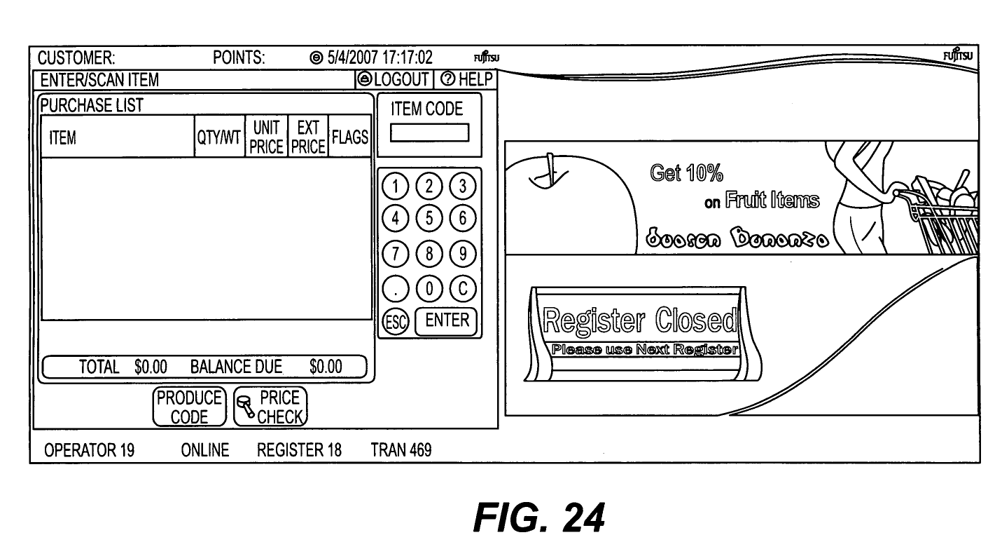

FIG. 24—illustrates an example screen where a register is unavailable for further transactions and is in the register closed state.

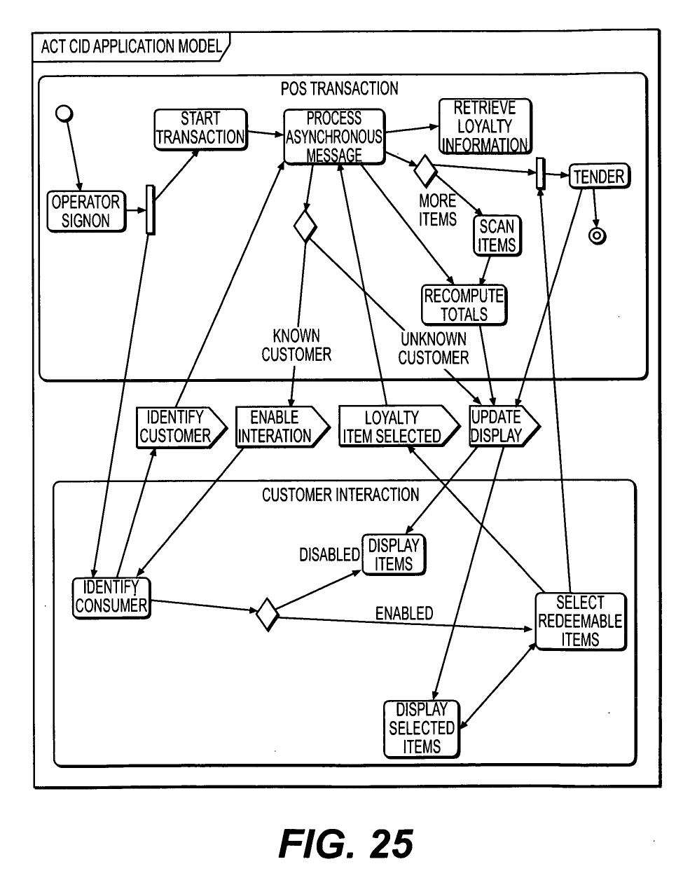

FIG. 25 schematically illustrates an alternate view of the logical progression of the work flow in accordance with the example shown in FIGS. 1 through 24. Referring to FIG. 25, a register leaves the register closed state upon “Operator Sign on.” Then upon the start of a transaction, the system sees if the customer identity is know, such as via his loyalty card or phone number as discussed above. If the customer is known, then interaction with the customer's input/output device is enabled. If the customer is unknown, then interaction is not enabled, and the customer's display is updates as items are scanned as discussed above. As seen in FIG. 25, messages are passed between the customer's input/output device and the POS in an asynchronous manner as indicated in the work flow discussed above. As seen in FIG. 25, if interaction is enabled as a result of identifying the customer, redeemable items can be selected and there are messages so indicating passed between the POS and the customer's input/output device, and the associated updated accordingly.

The above embodiments are only some of the variety of possible scenarios where an interactive customer device can be in use while the POS transaction is in process. The present invention can also be used in a remote deployment of the customer input/output device. And, while certain embodiments can use input/output devices on a single system, the customer input/output device could be deployed on a standalone computer connected to the POS system by a variety of communications links (e.g. Ethernet). There is no logical difference in the operation in this remote deployment scenario.

1. A dual input/output device point of sale terminal comprising:
a message machine for receiving sending and processing messages;
an operator input/output device operatively coupled to and exchanging messages with the message machine; and
a customer input/output device operatively coupled to and exchanging messages with the message machine,
wherein the message machine maintains communicates with the customer input/output device so as to minimally impact operation of the operator input/output device.

2. A dual input/output device point of sale terminal according to claim 1, wherein the operator input/output device and the customer input/output device comprise touch screen devices.

3. A dual input/output device point of sale terminal according to claim 2, wherein the operator input/output device includes an integral card reader.

4. A dual input/output device point of sale terminal according to claim 2, further comprising a card reader operatively connected to receive customer information.
